(19) United States
(12) Patent Application Publication
(10) Pub. No.: US 2006/0175439 A1
(43) Pub. Date: Aug. 10, 2006

(54) Voltage and turbine speed control apparatus for a rotary atomizer

(76) Inventors: Gunnar van der Steur, Chesapeake City, MD (US); Edward F. Baker, Baltimore, MD (US)

Correspondence Address: E. Alan Uebler, Esq.;E. Alan Uebler, P.A., Lindell Square, Suite 4, 1601 Milltown Road, Wilmington, DE, 19808, US

(21) Appl. No.: 11/053,109

(22) Filed: Feb. 8, 2005

(51) Int. Cl. B05B 5/00

(52) U.S. Cl. 239/703; 239/700; 239/690

(57) ABSTRACT

Apparatus is provided for controlling both the high voltage and turbine speed in a rotary atomizer used in the electrostatic spray coating of a workpiece such as an automotive vehicle. A rotary bell cup spray atomizer carried by a maneuverable robot arm is charged to a high voltage potential which charges the atomized particles exiting the bell cup. The bell cup is rotatably driven by a turbine. The voltage to and speed of the atomizer, respectively, are regulated by a high voltage multiplier and a fiber optic transceiver. A low voltage electrical source remote from the robot arm assembly powers the voltage multiplier and the transceiver, both housed adjacent the atomizer, via two shielded, low-voltage, electrical cables extending from the low voltage source to the housing. One of the electrical cables connects to the multiplier to regulate the voltage applied to the atomizer. The other connects to the transceiver such that incoming electrical signals to the transceiver are converted to light signals which are transmitted to the turbine through at least one optical fiber, which light signals are then reflected backwardly from the turbine through at least one second optical fiber back to the transceiver and converted to electrical signals thereat. These signals control both the voltage applied to the particles and the rotational speed of the turbine.

### FIELD OF THE INVENTION

The invention relates to the electrostatic spray coating of articles generally, and is particularly suited for the spray painting of automotive vehicles.

### BACKGROUND OF THE INVENTION

In the electrostatic application of paint in the automotive finishing industry, paint may be delivered to a robotically maneuverable atomizer applicator. A plurality of sources may be employed, with each source providing a different color paint. During spraying, a high voltage is imposed on the atomizer, which imparts positive charges on the atomized paint droplets, which are then uniformly attracted to grounded articles being coated, all in known assembly-line fashion. High voltages can create critical safety concerns and hazards in these electrostatic operations, wherein the spray applicator itself must be maintained at a high voltage, typically 20,000 to 100,000 kV.

Two general types of spray atomizers are usually employed in paint finishing, specifically rotary atomizers and spray atomizers. This invention relates to spray coating with rotary bell cup atomizers.

Rotary atomizers rely primarily upon centrifugal forces to atomize the paint before it is applied to the object being coated, i.e. an automobile body. These centrifugal forces are generated by spinning the bell cup body at very high speeds, generally 20-100,000 revolutions per minute. The exiting edge of the bell cup is often sharp and serrated to enhance the atomization process. Rotational speed also directly influences atomization, that is, higher bell speeds produce smaller paint particles (higher degree of atomization).

To increase the paint transfer efficiency of a rotary atomizer, the system is charged to a high voltage potential, 20-100 kV. A controlled, low voltage is first delivered to the system. This low voltage, 0 to 21 VDC, is then sent to a voltage multiplier which steps up the voltage, up to several thousand times. This high voltage is then sent to the bell cup atomizer that directly charges the paint particles exiting the bell cup. These highly charged and finely atomized paint particles are then drawn to the grounded workpiece passing in adjacent proximity thereto, such as an automobile body, via electrostatic forces.

In such operations, a bundle of hoses is generally employed to supply the needed air for pneumatic controls and to act as conduits in supplying electrical controls for the system, in addition to supplying both the paint to be sprayed and cleaning solvents used to clean the system during and after operation. This bundle of hoses is usually fed into and through the controlled and maneuverable hollow robot arm through a robot mounting ring, then into a manifold assembly adjacent the atomizer.

The maneuverable robot arm has, at its distal end, a robot side base plate which is affixable to the complimentary base plate of the atomizer assembly which also houses the (air driven) turbine which drives the rotary atomizer. The hose bundle is fed through the robot arm into the manifold assembly, and each hose of the hose bundle, including the low voltage electrical lines, is mounted to the robot side base plate with either, generally, compression fittings or push lock fittings. When assembled, a counter bore on the turbine side base plate will accept a boss on the robot side base plate for each line of the hose bundle. Turbine speed is usually controlled by either a pneumatic or fiber optic signal that is first sent from a computerized controller through the hose bundle to the turbine motor. This signal is then reflected back from the turbine and back through the hose bundle to the computer controller. The controller then makes any necessary adjustments to the turbine speed by either adding more turbine drive air to increase the bell cup speed or turbine brake air to decrease the speed.

Many existing rotary atomizers utilize pneumatic signals for speed control. Such signals are produced by air pulses sent back from the turbine motor and are received at a microphone that converts that air signal into an electric signal which is then sent to the controller for turbine speed adjustments. While such a system is operating, a substantial amount of extraneous noise is generated. This noise is produced by turbine drive air, turbine brake air, motor bearing air and shaping air. Shaping air is used to control the spray pattern size. Some of this noise is received by the microphone, resulting in inaccurate speed readings and improper speed control.

More recently, rotary atomizer systems have employed fiber optic cabling to monitor and control turbine speed. This type of control is more reliable and accurate than the pneumatic speed control system in that ambient noise does not appreciably affect the fiber optic light signal. In these systems, the controller is connected to a remotely located fiber optic transceiver. The transceiver sends a light signal through the hose bundle within a glass or plastic optical fiber. The light is reflected off of one of the rotating parts within the turbine motor and is reflected back down the hose bundle via a second glass or plastic fiber to the transceiver and controller, thereby providing speed control.

During the spraying cycle, as the robot moves the atomizer around the workpiece, these long glass fibers are constantly being bent, twisted and pulled within the hose bundle. After time, one or both of these fibers will break. When that happens, all speed control is lost. Replacing a broken fiber within a hose bundle, and thereby interrupting assembly line production, is very time consuming and expensive in terms of production downtime.

In these existing systems, as mentioned previously, high voltage is supplied to the turbine by first supplying low voltage to a voltage multiplier that steps up the voltage. This voltage is then transferred to the paint by charging the bell cup. A problem with this high voltage results from its tendency to easily travel across surfaces, interfering with other electronic devices, and posing a safety concern. Properly grounding all surrounding conductive components is critical to safe operation. If the components within the hose bundle are not properly grounded, then the high voltage controller may receive an inaccurate voltage feedback signal from the atomizer, thereby either creating the wrong voltage at the atomizer, or completely faulting out the system.

As with turbine speed faults, voltage faults can result in expensive production downtime.

### BRIEF DESCRIPTION OF THE DRAWINGS

In the accompanying figures:

FIG. 1 is a perspective view of the spray coating apparatus of the invention attached to the distal end of a multi-axially maneuverable robotic arm and showing its component parts, including rotary atomizer, paint supply lines, air lines and control signal electrical supply lines;

FIG. 2 is a schematic diagram, partially in section, of the voltage and speed control apparatus of the invention;

FIG. 3 is an enlarged schematic view, also partially in section, of a portion of the apparatus shown in FIG. 2; and

FIG. 4 is a block diagram depicting the arrangement of and interaction between the key components according to the invention.

FIG. 5 is a simplified circuit diagram depicting the interconnections of the various components of the invention.

### SUMMARY OF THE INVENTION

Apparatus is provided for controlling both high voltage and turbine speed in a rotary atomizer used in the electrostatic spray coating of a workpiece. The apparatus includes a rotary bell cup spray atomizer carried by a maneuverable robot arm, the atomizer capable of atomizing and spraying a coating product therefrom onto a grounded workpiece, such as an automotive vehicle passing in adjacent proximity thereby, on controlled demand. In such coating process, the atomizer is charged to a high voltage potential, which voltage potential imparts positive charges to the atomized coating product particles exiting the bell cup. The rotary bell cup is rotatably driven by a turbine motor having adjustable rotational speed control, with the voltage to and speed of the rotary atomizer being regulated by a high voltage multiplier and a fiber optic transceiver, respectively. The transceiver is housed adjacent to the atomizer in fixed relationship thereto, the transceiver housing being affixed distally of the robot arm and proximally of the atomizer. The voltage and current for both the high voltage control and speed control are supplied from a low voltage electrical source remote from the robot arm and transmitted, respectively, to the voltage multiplier and the transceiver via two shielded, low-voltage, electrical cables extending from the low voltage source to the housing, whereat one of the electrical cables connects to the multiplier to regulate the voltage applied to the atomizer and the other cable connects to the transceiver. At and by said transceiver, incoming electrical signals are converted to light signals which then are transmitted to the turbine motor through at least one optical fiber and impinge thereon, the light signals then reflecting backwardly from the turbine through at least one second optical fiber back to the transceiver and being converted to feedback electrical signals thereat, these optical signals and feedback signals being employed to control the rotational speed of the turbine. The housing into and through which the electrical cables and optical fibers pass, which houses the transceiver, is electrically shielded from the environment.

The apparatus is useful in the assembly line, robotic painting of vehicles. The two low voltage electrical cables both preferably are externally insulated and shielded multi-conductor cables, each cable comprising three (3) separately insulated multi-stranded wire conductors. The external cable insulation and the conductor wire insulation preferably comprise fluorocarbon polymeric insulation, such as a fluorocarbon polymer of polytetrafluoroethylene (PTFE), fluorinated ethylene propylene (FEP) or perfluorovinylalcohol (PFA), with the most preferred insulation being PTFE. The connection between the shielded low-voltage cables and the voltage multiplier and transceiver is preferably effected through a complimentary 7-pin male-female electrical socket connector assembly, with the seventh pin being connected to ground.

### DETAILED DESCRIPTION OF THE INVENTION AND PREFERRED EMBODIMENTS WITH REFERENCE TO THE DRAWINGS

Apparatus is provided for controlling both the high voltage and turbine speed in a rotary atomizer used in the electrostatic spray coating of a workpiece. The apparatus includes a rotary bell cup spray atomizer carried by a maneuverable robot arm, the atomizer capable of atomizing and spraying a coating product therefrom onto a grounded workpiece, such as an automotive vehicle passing in adjacent proximity thereby, on controlled demand. The atomizer is charged to a high voltage potential which charges the particles exiting the bell cup. The bell cup is rotatably driven by a turbine motor having adjustable rotational speed control. The voltage to and speed of the rotary atomizer, respectively, are regulated by a high voltage multiplier and a fiber optic transceiver. The transceiver housing is affixed distally of the robot arm and proximally of the atomizer and adjacent thereto. The voltage and current for both the high voltage control and speed control are supplied from a low voltage electrical source remote from the robot arm assembly and are transmitted, respectively, to the voltage multiplier and the transceiver via two shielded, low-voltage, electrical cables extending from the low voltage source to the housing, whereat one of the electrical cables connects to the multiplier to regulate the voltage applied to the atomizer and the other cable connects to the transceiver. At and by said transceiver, incoming electrical signals are converted to light signals which then are transmitted to the turbine motor through at least one optical fiber and impinge thereon, the light signals then reflecting backwardly from the turbine through at least one second optical fiber back to the transceiver, these optical signals and feedback being employed to control the rotational speed of the turbine. The housing into and through which the electrical cables and optical fibers pass, which houses the transceiver, is electrically shielded from the environment.

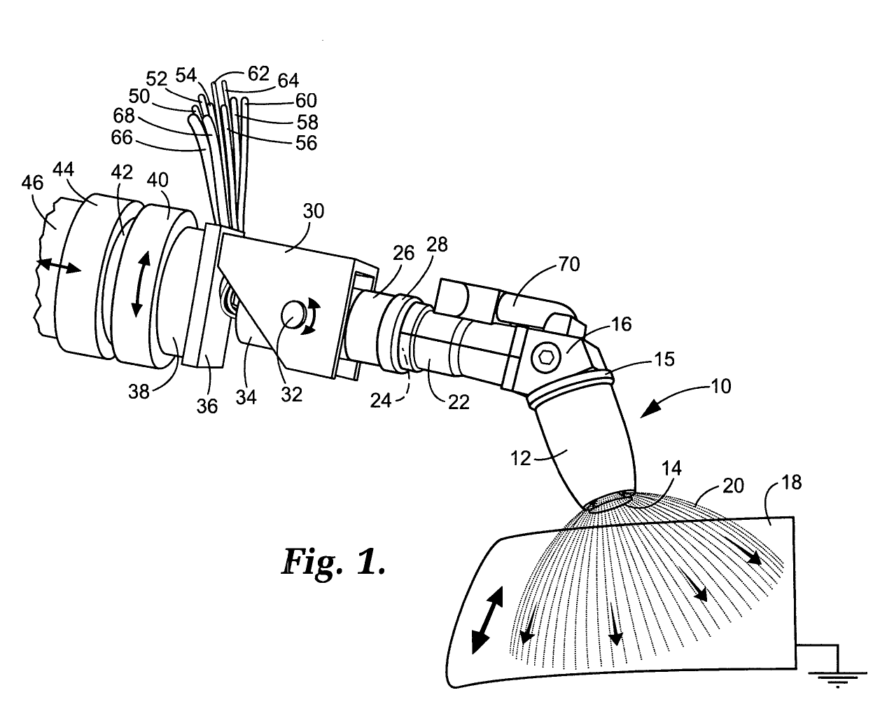

A detailed description of the invention and preferred embodiments is best provided with reference to the accompanying drawings wherein FIG. 1 shows a perspective view of one embodiment of the apparatus according to the invention claimed herein. In FIG. 1, a workpiece 18, such as, for example, an automotive vehicle passing along a paint assembly line in a paint room, is depicted being spray painted with atomized paint 20 emitted from the rotary atomizer 10 through the rotating bell head 14. Note that, in operation, the workpiece 18 is grounded, as indicated in the figure.

The rotary atomizer 10 is affixed to the distal end of the robotic arm 34 by means of a connecting ring 15 connecting the atomizer housing 12 to the connector joint assembly 16 which, in turn, connects to the robotic arm 34 by means of split housing 22, distal (turbine side) base plate 24, connecting ring 28, connecting the turbine side base plate 24 and robot side base plate 26, connected via pivot joint housing 30 and mounted on pivot axle 32, thence to the robotic arm 34. The proximal ends of the robotic arm 34 and housing 30 are affixed to connector base 36 as shown, with the base 36 affixed to rotatable arm extension 38 by connecting ring 40, the rotatability indicated by the double-headed arrow, with connection to the axially movable (axial double-headed arrow) robot arm being effected through arm extension 42 and connecting ring 44. The movement in space of the atomizer assembly 10 is controlled robotically in three dimensions by means of the pivoting housing 30 and pivot 32 (up and down), the axially rotatable joint 40, and the axially positionable robot arm 46, all such movements being depicted schematically by the arrows shown.

Air lines, low voltage electrical lines, and solvent and paint supply lines are depicted connected to the system at the pivot joint housing 30 and extending into the robot arm 34 at its proximal end thereof. Included in this hose bundle are air lines 50, 52, 54, 56, 58 and 60, low voltage electrical cables 62 and 64, and paint and solvent supply and return lines 66 and 68. The air lines provide air needed for turbine drive and braking and for shaping air, for controlling the shape of the pattern of the atomized paint spray 20 being emitted from the atomizer. The electrical cables 62 and 64 are low voltage cables, each of which preferably comprises 3-wire, insulated and shielded conductors, described more fully below. The paint lines 66 and 68 provide for supply of paint, solvent and return of excess paint. Also included in FIG. 1, shown affixed to the housing 22, is a high voltage multiplier 70 which transforms the low voltage input signals to very high voltage potentials, typically 20-100,000 kV, which are then sent to the bell cup atomizer that directly charges the atomized paint particles 20 as they emerge from the atomizer 10, to be electrically attracted to the grounded workpiece 18, as shown.

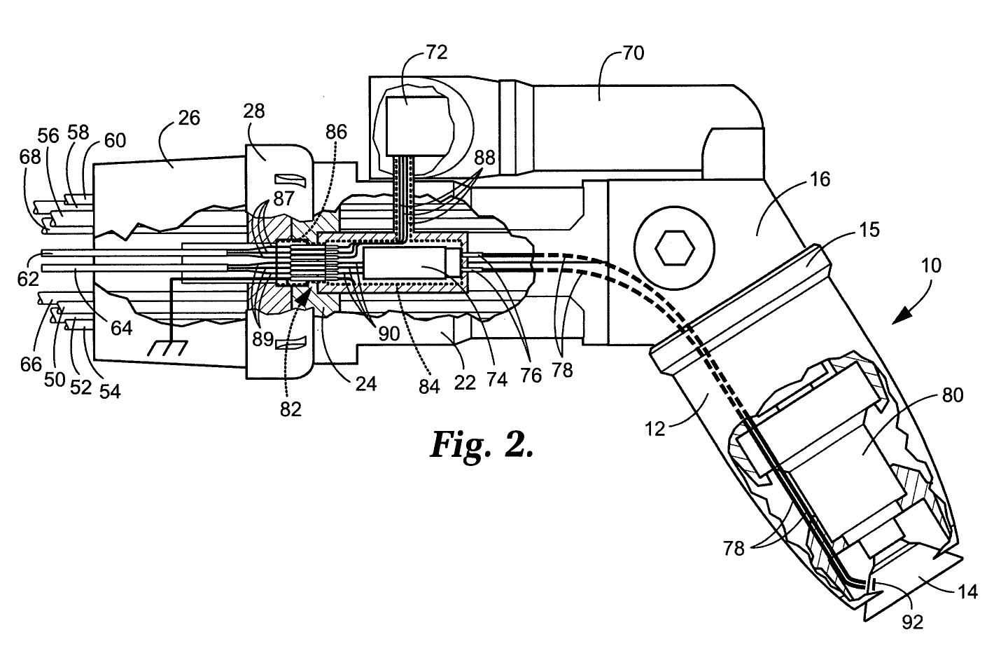

FIG. 2 depicts, schematically and in partial section, the preferred arrangement of the voltage and speed control mechanisms provided by the present invention. Therein, low voltage electrical signals, controlled by a remote computer controller (not shown), are sent via cables 62,64 to the electrical connector 82, which is a key component in the assembly. This connector 82 is preferably a 7-pin male/female socket assembly mounted within the housing 22 as shown. The hose bundle entering the system, including the various hoses 50-68, is as described in FIG. 1, and those descriptions are not repeated here.

With reference to FIG. 2, it is seen that both high voltage and speed control signals are sent to the atomizer 10 via the two separate low voltage cables 62 and 64 from a high voltage source and turbine speed controller, respectively. Each cable 62,64 is insulated, preferably with a fluorocarbon insulation such as TEFLON®, is shielded, and contains three insulated, multi-strand copper electrical conductors 87,89. Both cables 87,89 connect to the female side of the seven-pin socket assembly 82, where each of the six conductors (three for each cable) are soldered to corresponding female connectors. The shield for the turbine speed control is soldered to the seventh pin as well as to the conductive sleeve inside the female socket assembly. The seventh pin is used as a ground.

When the robot side and turbine side base plates 26,24 are attached to one another, the low voltage female socket assembly in the robot side base plate is connected, electrically, to the seven pin male side of the socket connector assembly 82 in the turbine side base plate 24. Three of the conductors 90 from one of the low voltage cables are attached to a fiber optic transceiver 74 as shown. A suitable transceiver for use in this system is one marketed by Advanced IC Engineering, Inc., under model designation “FOX2”. The transceiver 74 receives the low voltage signal, supplied from the turbine speed controller card, and converts it to a light signal which is sent to the turbine motor 80 via a first optical fiber 78. This transmitted input light signal impinges on and reflects off one of the rotary parts within the turbine motor, depicted schematically as the rotating cup 14, and the reflected signal travels back down the second fiber 78, back to the transceiver 74. The transceiver 74 converts this reflected light signal to a low voltage electrical feedback signal that is then sent back to the turbine speed card at the remote controller. The turbine speed card uses this signal to adjust the turbine speed to a desired setting, and is varied as desired based on the sensed frequency of rotation of a timing mark 92 placed on the rotating turbine part onto which the incoming light signal impinges.

The other three conductors 88, from the other low voltage cable 62, are attached as shown to the high voltage multiplier 72. The shield from the transceiver cable is soldered to a conductive sleeve within the female socket assembly, indicated by the dotted lines shown in the figure.

The fiber optic transceiver 74 and the male and female socket assembly 82 are also shielded with grounded sleeves 84,86, indicated by dotted lines, which ensure that electrical interference will be eliminated. The transceiver 74 is also preferably surrounded with an epoxy to help insulate it from the high voltage.

Compare this system depicted in FIG. 2 with previous control systems wherein turbine speed has been controlled by a (relatively) long fiber optic cable, extending from the remote computer controller, through the hose bundle, thence to the turbine motor, through which an optical signal is sent to the turbine, reflected back from the turbine and sent back to the controller, a system wherein the (relatively) long optical cables are subjected to rapid and spatially changing movement and flexure during the robotic painting operation. Such repeated flexing often results in breakage of the brittle optical fibers, and necessitates a shutdown of operations, causing a costly delay. Contrast this previous system with that of the present invention, wherein optical fibers 78 extend only within the housing 22 and atomizer housing 10 and are never subjected to flexure. The advantages of the present system, thus, should be readily apparent.

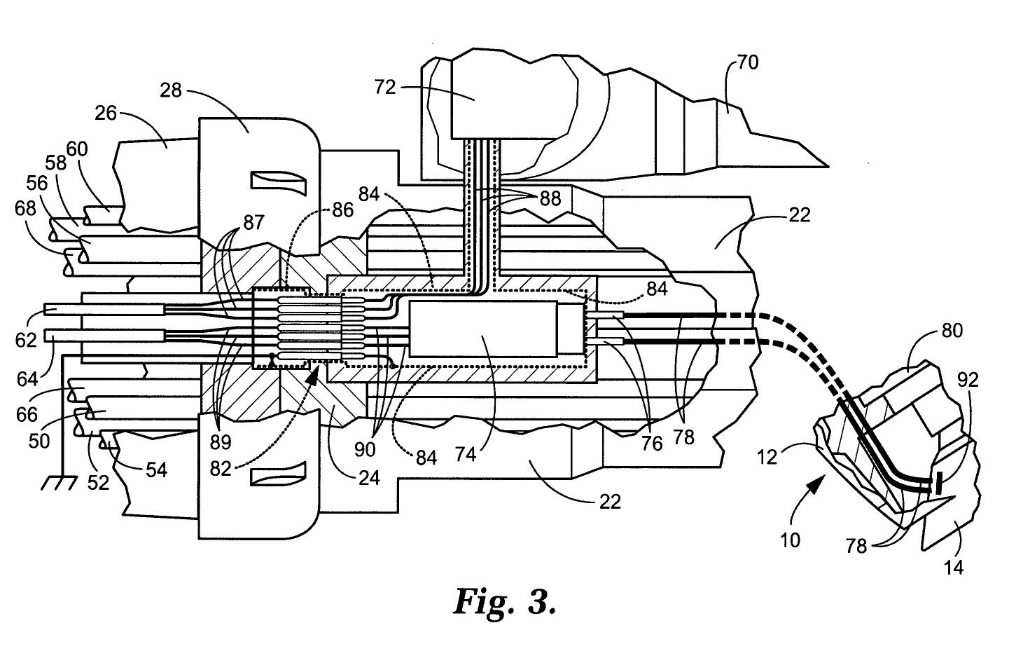

FIG. 3 represents an enlarged view of the partial sectional view of FIG. 2, to better illustrate the details of the assembly of the electrical and optical components within the housing 22 and the atomizer 10. The individual components are as described previously herein.

The hose bundle, which includes the various pneumatic, electrical and paint lines, extends into and through the robot side base plate 26, which is affixed to the turbine side base plate 24. Low voltage electrical signals transmitted from a remote controller, not shown, enter insulated and shielded cable 62 and feed into 7-pin electrical connector 82 via 3-wire, multi-strand, insulated conductors 87. These electrical signals are transmitted by conductors 88 to voltage multiplier 72 (cascade) whereat the voltage is stepped up and fed to the atomizer 10, whereat ionic charges are imparted to the particles of paint emitted from the atomizer 10.

Separate low voltage electrical signals transmitted from the remote controller enter insulated and shielded cable 64 and also feed into the 7-pin electrical connector 82 via 3-wire, multi-stranded and insulated conductors 89. From connector 82, these signals are sent to fiber optic transceiver 74 via multi-strand 3-wire conductors 90, at which the electrical signals are transformed into light signals. The light signals emitted from transceiver 74 are directed via a fiber optic connector 76 and conductor 78 to a convenient part of the rotating turbine motor 80, depicted in the figure as the rotating bell head 14 of the atomizer 10. A timing mark 92 placed on the bell head produces a measure of the rotational speed of the head. The optical signal sent to the bell head reflects back through the second fiber optic conductor 78 and connector 76 to the transceiver 74, and is converted thereat to an electrical signal by transceiver 74, and then sent back to the controller. The incoming light, the reflected light signal, and the timing mark all provide feedback which is sent backwardly through the system to the remote controller and serve to regulate the speed of the turbine motor 80.

The system is fully shielded electrically from the environment by conductive grounded sleeves 84,86, shown for convenience as dotted lines, these surrounding sleeves enveloping the connector 82, the transceiver 74 and the conductors 88 and 90 leading to the voltage multiplier 72 and transceiver 74.

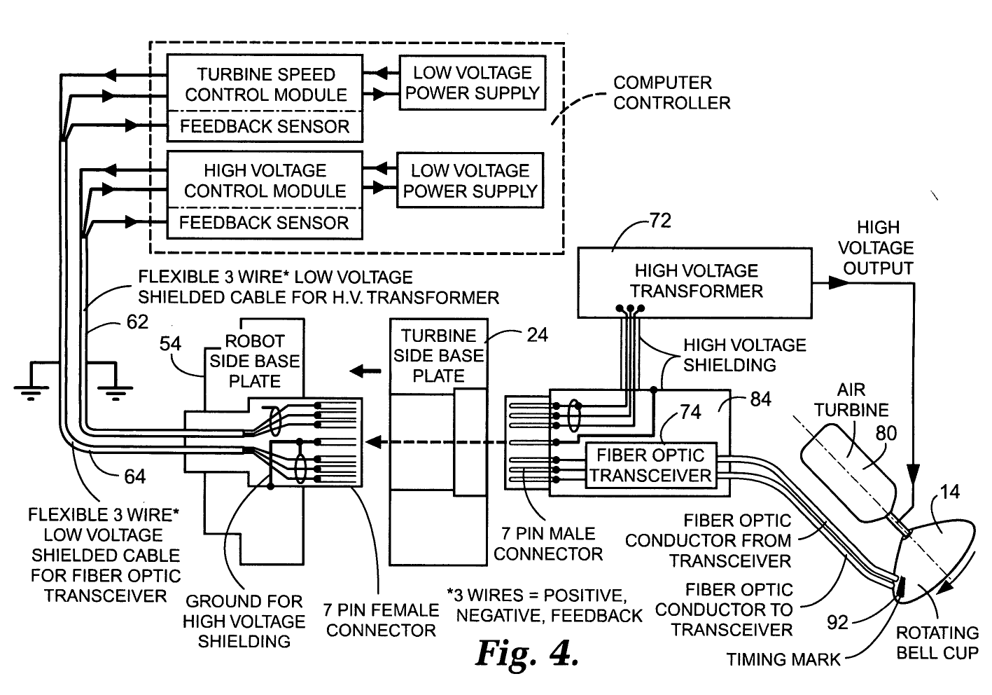

To better illustrate the relationship of the various components of the voltage and speed control apparatus according to the invention, FIG. 4 shows a block diagram of the key components. Therein, low voltage power supplies are used to generate low voltage electrical signals which are sent to a turbine speed control module and to a voltage control module, respectively, each of which includes a feedback sensor. The computer control of the system is schematically represented by the dashed box.

Low voltage electrical signals are sent via insulated, shielded cables 62,64, each of which may be low voltage, 3-wire cables. Input electrical signals though cable 62, indicated by the directional arrows, are fed through the 7-pin connector and to the high voltage transformer 72 where these signals are stepped up in voltage and sent to the atomizer/turbine. Input electrical signals through cable 64 are fed through the 7-pin connector as shown and to the fiber optic transceiver 74, wherein the electrical signals are converted to light signals and sent on via fiber optic cable 78 to a rotating part of the turbine 80, all as discussed in detail hereinabove, which light signal is reflected back from the turbine through a second fiber optic cable to the transceiver 74 and converted thereat to an electrical signal, and then sent back to the computer controller for appropriate adjustment. Key components of the system are all electrically shielded, as indicated schematically in the diagram. These input signals and reflected signals serve to provide feedback control for both voltage and turbine speed in this rotary atomizer system.

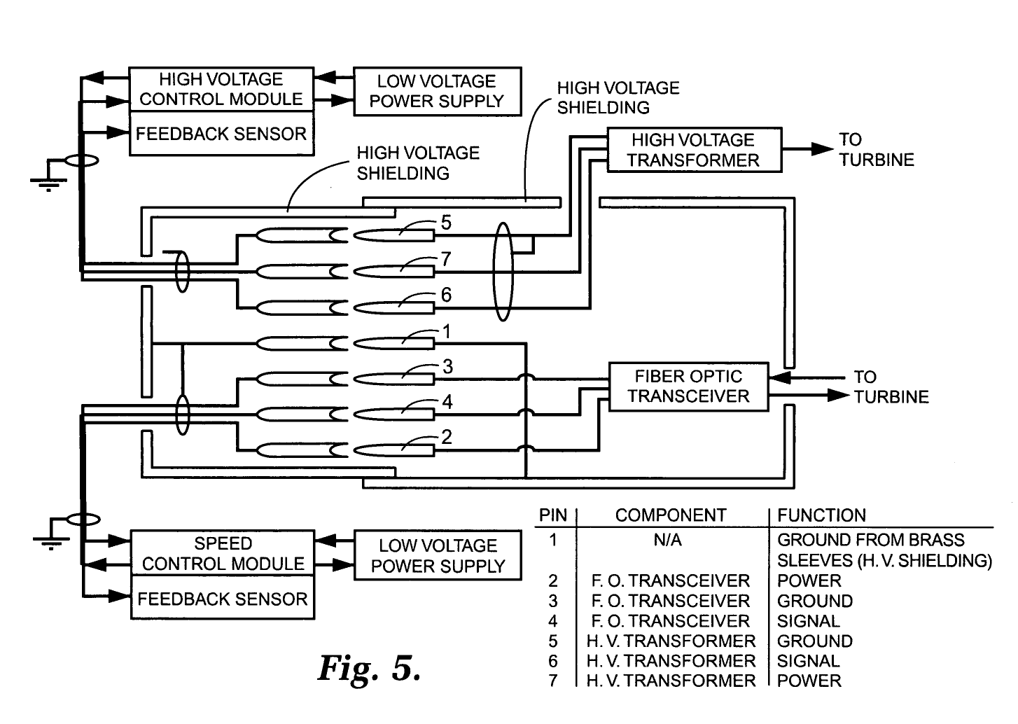

In FIG. 5, which is a simplified circuit diagram, the interconnections of the various components of the apparatus of the invention are illustrated.

While the invention has been disclosed herein in connection with certain embodiments and detailed descriptions, it will be clear to one skilled in the art that modifications or variations of such details can be made without deviating from the gist of this invention, and such modifications or variations are considered to be within the scope of the claims hereinbelow.

What is claimed is:

1. In the electrostatic spray coating of a workpiece, apparatus for controlling both high voltage and turbine speed in a rotary atomizer, the apparatus comprising:
a rotary bell cup spray atomizer carried by a maneuverable robot arm, the atomizer capable of atomizing and spraying a coating product therefrom onto a grounded workpiece passing in adjacent proximity thereby on controlled command,
said coating product being supplied from a source of supply through at least one distribution circuit and to and through said robot arm and atomizer,
the atomizer being charged to a high voltage potential, which voltage potential imparts positive charges to the atomized coating product particles exiting said bell cup,
said rotary bell cup being rotatably driven by a turbine motor having adjustable rotational speed control,
the voltage to and speed of said rotary atomizer being regulated by a high voltage multiplier and a fiber optic transceiver, respectively, said transceiver being housed adjacent to said atomizer in fixed relationship thereto, said transceiver housing being affixed distally of said robot arm and proximally of said atomizer,
the voltage and current for both the high voltage control and speed control being supplied from a low voltage electrical source remote from said robot arm and transmitted, respectively, to said multiplier and transceiver via two shielded, low-voltage, electrical cables extending from said source to said housing, whereat one of said electrical cables connects to said multiplier to regulate the voltage applied to said atomizer and the other of said cables connects to said transceiver such that, at and by said transceiver, incoming electrical signals are converted to light signals which then are transmitted to said turbine motor through at least one optical fiber and impinge thereon, said light signals reflecting backwardly from said turbine through at least one second optical fiber back to said transceiver and being converted to feedback electrical signals thereat, which feedback signals are employed to control the rotational speed of said turbine,
wherein said housing into and through which said electrical cables and said optical fibers pass, and which houses said transceiver, is electrically shielded from the environment.

2. The apparatus of claim 1 wherein said coating product is paint.

3. The apparatus of claim 1 wherein said workpiece is an automotive vehicle body component.

4. The apparatus of claim 1 wherein said two low voltage electrical cables each comprise an externally insulated and shielded multi-conductor cable, each said cable comprising three (3) separately insulated wire conductors.

5. The apparatus of claim 4 wherein said external cable insulation and said wire insulation comprise insulation of a fluorocarbon polymer.

6. The apparatus of claim 5 wherein said insulation is of a fluorocarbon polymer selected from the class consisting of polytetrafluoroethylene (PTFE), fluorinated ethylene propylene (FEP) and perfluorovinylalcohol (PFA).

7. The apparatus of claim 6 wherein said insulation comprises PTFE.

8. The apparatus of claim 4 wherein said insulated wire conductors are multi-stranded wire conductors.

9. The apparatus of claim 4 wherein connection between said shielded low-voltage cables and said voltage multiplier and transceiver is effected through a complimentary 7-pin male-female electrical socket assembly, the seventh pin being connected to ground.

10. The apparatus of claim 9 wherein said socket assembly is positioned within the junction formed by a robot side base plate and a turbine side base plate connecting said robot arm to said housing.
